(19) United States
(12) Patent Application Publication
(10) Pub. No.: US 2026/0319422 A1
(43) Pub. Date: Oct. 15, 2026

(54) IMAGE FORMING APPARATUS THAT CONTROLS TIMING OF TRANSPORT OF SECOND RECORDING MEDIUM SUBSEQUENT TO FIRST RECORDING MEDIUM TO FIXING NIP PORTION

(71) Applicant: KYOCERA Document Solutions Inc., Osaka (JP)

(72) Inventor: Akihiro KONDO, Osaka (JP)

(73) Assignee: KYOCERA Document Solutions Inc., Osaka (JP)

(21) Appl. No.: 19/637,789

(22) Filed: Apr. 2, 2026

(30) Foreign Application Priority Data
Apr. 10, 2025 (JP) 2025-065284

(51) Int. Cl. G03G 15/00; G03G 15/20

(52) U.S. Cl. CPC G03G 15/657; G03G 15/2039; G03G 15/206; G03G 2215/00413; G03G 2215/0059

(57) ABSTRACT

An image forming apparatus includes an image forming device, a transport device, a fixing part, a heater, a pressing part, a temperature sensor, and a control device that functions as a controller. The controller is configured to, when a second recording medium passes through a fixing nip portion, cause, when an image is formed in a corresponding region of the second recording medium formed when passing through a first region through which a first recording medium does not pass, the transport device to transport the second recording medium to a fixing nip portion when a temperature of the first region becomes lower than a first threshold temperature, and cause, when no image is formed in the corresponding region, the transport device to transport the second recording medium to the fixing nip portion when the temperature becomes lower than a second threshold temperature higher than the first threshold temperature.

### INCORPORATION BY REFERENCE

This application claims priority to Japanese Patent Application No. 2025-065284 filed on Apr. 10, 2025, the entire contents of which are incorporated by reference herein.

### BACKGROUND

The present disclosure relates to an image forming apparatus including a fixing device that fixes an image formed on a recording medium such as a recording sheet by thermal compression.

An electrophotographic image forming apparatus such as a copy machine or a multifunction peripheral includes a fixing device that fixes an image formed on a recording medium. As the fixing device, a fixing device including a fixing belt that has a cylindrical shape and is configured to be rotatable, a heater that heats the fixing belt, and a pressing part that holds the fixing belt between itself and the heater, forms a fixing nip portion in which a recording medium is nipped and transported, with the fixing belt, and rotates the fixing belt in a driven manner is known. In the fixing device, an image formed on the recording medium is fixed on the recording medium in a fixing nip portion through heating and pressing (thermal compression). Further, the fixing device is generally provided with a temperature sensor that detects a temperature of the heater, to maintain a temperature of the fixing belt that nips and heats the recording medium, or the like at an appropriate temperature.

When the size of the recording medium passing through the fixing nip portion is small, a central portion of the fixing belt in a rotation axis direction (a width direction perpendicular to a transport direction of the recording medium) becomes a sheet passing region through which the recording medium passes, but the outer side of the fixing belt becomes a non-sheet passing region through which the recording medium does not pass.

When the recording medium passes through the fixing nip portion, heat of the fixing belt is removed by the recording medium. For this reason, when a recording medium having a small size passes through the fixing nip portion, a temperature difference between the central portion (sheet passing region) where heat is removed by the recording medium and both end portions (non-sheet passing region) where almost no heat is removed by the recording medium becomes large, and an excessive temperature increase is likely to occur in both end portions (non-sheet passing region) of the fixing belt. That is, an excessive temperature increase region is formed in both end portions of the fixing belt.

For this reason, when a recording medium having a size greater than a recording medium having a small size passes through the fixing nip portion subsequently to the recording medium having a small size (that is, a recording medium passes through the excessive temperature increase region), an image (toner image) formed on the recording medium may be excessively heated and become molten in the excessive temperature increase region, toner may become stuck to the fixing belt or the pressing part, and an image defect may occur. So-called hot offset occurs. Further, a curl amount of the recording medium may become excessively large.

To suppress the occurrence of harmful effects such as hot offset or curl, performing control (temperature equalization control) for making the fixing belt and the heater run idle to equalize the temperature of the fixing belt in the width direction before a recording medium having a large size passes through the fixing nip portion after a recording medium having a small size has passed through the fixing nip portion has been proposed.

However, if the recording medium having a large size passes through the fixing nip portion after a recording medium having a small size has passed through the fixing nip portion, when no image is formed in a range corresponding to the excessive temperature increase region, a problem that hot offset occurs is reduced. Nevertheless, when the temperature equalization control as described above is performed, work for image forming is stopped until the temperature equalization control is completed and productivity is degraded.

In general, a technique for reducing a waiting time until work for image forming starts, by determining whether an image is formed in a range corresponding to a non-sheet passing region for a second recording medium (second recording material) passing through a fixing nip portion subsequently to a first recording medium (first recording material) and changing processing contents between when an image is formed in the range and when no image is formed in the range is known.

### SUMMARY

As one aspect of the present disclosure, a technique improved over the above-described technique is proposed.

An image forming apparatus according to one aspect of the present disclosure includes an image forming device, a transport device, a fixing part, a heater, a pressing part, a temperature sensor, and a control device. The image forming device is configured to form an image based on image data on a recording medium. The transport device is configured to continuously transport a plurality of the recording media in a transport path on which the recording medium is to be transported. The fixing part has a cylindrical rotatable part. The heater is configured to heat the fixing part to a predetermined fixing temperature. The pressing part is configured to hold the fixing part between itself and the heater, form a fixing nip portion in which the recording medium after image forming by the image forming device is nipped and transported, with the fixing part, and rotate the fixing part in a driven manner. The temperature sensor is configured to detect a temperature of the heater. The control device includes a processor, and functions as a controller by the processor executing a control program. The controller is configured to control driving of the heater on the basis of a detection temperature of the temperature sensor. The heater is configured to selectively heat each region divided along a rotation axis direction of the fixing part, and the controller is configured to, when a second recording medium having a size in a width direction perpendicular to a transport direction of the recording medium greater than a first recording medium passes through the fixing nip portion subsequently to the first recording medium, and when the second recording medium passes through a first region through which the first recording medium does not pass, cause, when an image is formed in a corresponding region of the second recording medium formed when passing through the first region, the transport device to transport the second recording medium to the fixing nip portion when a temperature of the first region becomes lower than a predetermined first threshold temperature, and cause, when no image is formed in the corresponding region of the second recording medium overlapping the first region, the transport device to transport the second recording medium to the fixing nip portion when the temperature of the first region becomes lower than a predetermined second threshold temperature higher than the first threshold temperature.

### BRIEF DESCRIPTION OF THE DRAWINGS

FIG. 1 is a functional block diagram schematically showing a main internal configuration of an image forming apparatus according to a first embodiment.

FIG. 2 is a diagram illustrating blocks into which image data is divided.

FIG. 3 is a perspective view showing an example of a fixing device provided in the image forming apparatus.

FIG. 4 is a cross-sectional view schematically showing an example of the fixing device.

FIG. 5 is a plan view schematically showing an example of a configuration of a heater provided in the fixing device.

FIGS. 6A to 8B are image diagrams showing an example of a temperature distribution of the heater.

FIG. 9 is a flowchart illustrating an example of processing that is performed by a control device of the image forming apparatus.

FIG. 10 is a functional block diagram schematically showing a main internal configuration of an image forming apparatus according to a second embodiment.

FIG. 11 is a plan view schematically showing an example of a configuration of a heater.

### DETAILED DESCRIPTION

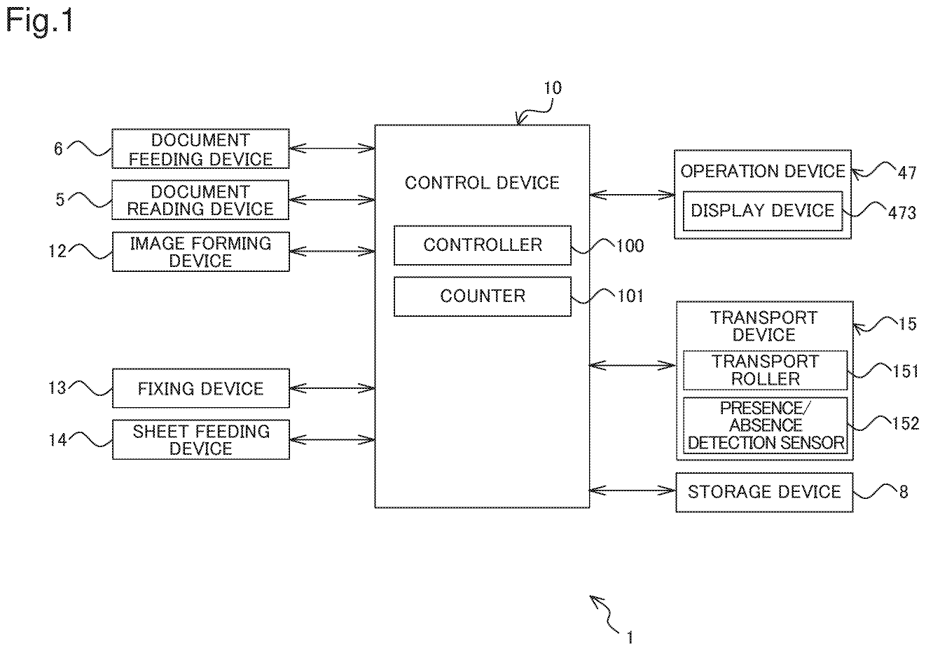

Hereinafter, an image forming apparatus according to an embodiment of the present disclosure will be described with reference to the drawings. FIG. 1 is a functional block diagram schematically showing a main internal configuration of an image forming apparatus according to a first embodiment of the present disclosure. An image forming apparatus 1 is, for example, a multifunction peripheral having a plurality of functions such as a copy function, a printer function, a scanner function, and a facsimile function.

The image forming apparatus 1 includes a control device 10, a document feeding device 6, a document reading device 5, an image forming device 12, a fixing device 13, a sheet feeding device 14, a transport device 15, an operation device 47, and a storage device 8.

The document feeding device 6 is configured to be opened and closed by a hinge or the like on an upper surface of the document reading device 5. The document feeding device 6 functions as a document retention cover in reading a document placed on a platen glass. The document feeding device 6 is an auto document feeder (ADF), includes a document tray, and feeds documents placed on the document tray to the document reading device 5.

The document reading device 5 includes a scanner and reads a document fed from the document feeding device 6 or a document placed on the platen glass. The document reading device 5 can sequentially read a plurality of document images fed from the document feeding device 6.

A case where a document reading operation is performed by the image forming apparatus 1 will be described. The document reading device 5 optically reads an image of a document fed to the document reading device 5 by the document feeding device 6 or a document placed on the platen glass and generates image data. The image data generated by the document reading device 5 is stored in an image memory or the like.

A case where an image forming operation is performed by the image forming apparatus 1 will be described. The image forming device 12 includes a photosensitive drum, a charging device, an exposure device, a developing device, and a primary transfer device for each color, and is configured to form an image on a recording sheet serving as a recording medium by secondary transfer through an intermediate transfer belt. The image forming device 12 forms an image on the recording sheet fed from the sheet feeding device 14 on the basis of image data generated by the document reading operation, image data stored in the image memory or the like, image data received from a computer connected via a network, or the like to form a printed matter.

The fixing device 13 is a fixing device including a heating roller, a pressing roller, and a driving mechanism that rotationally drives these rollers, and heats and presses the recording sheet on which the image is formed by the image forming device 12, with a nip by both rollers to fix the image on the recording sheet. The recording sheet subjected to fixing processing is discharged to a discharge tray.

The sheet feeding device 14 includes a sheet feeding cassette, a pick-up roller that picks up a recording sheet from the sheet feeding cassette and feeds the recording sheet to the image forming device 12, a transport roller, a transport path, and a rotational driving mechanism of each roller.

The transport device 15 continuously transports a plurality of recording media in the transport path on which the recording medium is to be transported. The transport device 15 includes the transport path that connects the sheet feeding device 14 and the discharge tray, transport rollers 151 provided in the transport path at appropriate places, and a presence/absence detection sensor 152 that detects the presence or absence of a recording medium. The presence/absence detection sensor 152 is provided downstream of the fixing device 13 in a transport direction, for example.

The operation device 47 includes various hard keys that are operated by a user, and receives instructions such as an image forming operation execution instruction from the user for various operations and processing executable by the image forming apparatus 1 according to operations on the hard keys.

The operation device 47 includes a display device 473 that displays operation guidance or the like to the user. The operation device 47 receives an input of an instruction from the user based on an operation (touch operation) of the user on a screen displayed on the display device 473 via a touch panel in the display device 473.

The display device 473 includes a liquid crystal display (LCD). When the user performs an operation to touch a button or a key displayed on the screen, the touch panel receives an instruction associated with a position at which the touch operation has been performed. In this case, the touch panel functions as an operation device.

The storage device 8 is a large capacity storage device such as a hard disk drive (HDD) or a solid state drive (SSD), and stores various control programs and the like.

The control device 10 includes a processor, a random access memory (RAM), a read only memory (ROM), and a dedicated hardware circuit. The processor is, for example, a central processing unit (CPU), an application specific integrated circuit (ASIC), or a micro processing unit (MPU).

The control device 10 functions as a controller 100 and a counter 101 by an operation of the above-described processor according to a control program stored in the storage device 8, or the like. It should be noted that the controller 100 and the like may be configured with a hardware circuit without depending on the operation according to the control program by the control device 10. Hereinafter, unless otherwise specified, the same applies to each embodiment.

The controller 100 administrates overall operation control of the image forming apparatus 1. The controller 100 is connected to the document feeding device 6, the document reading device 5, the image forming device 12, the fixing device 13, the sheet feeding device 14, the transport device 15, the operation device 47, and the storage device 8, performs driving control and the like of each device, and executes various kinds of processing and the like necessary for image forming by the image forming apparatus 1.

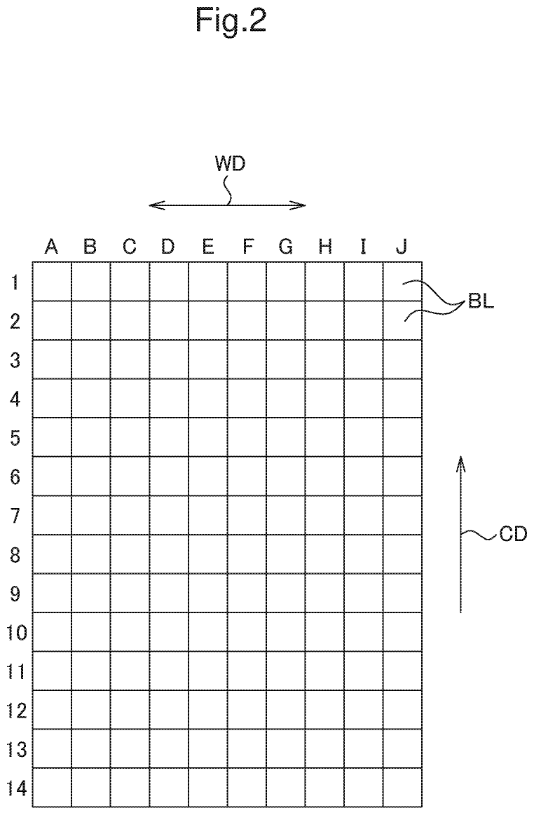

For each of a plurality of blocks formed by dividing image data for one page along a transport direction of a recording medium and a width direction perpendicular to the transport direction, the counter 101 counts the number of dots based on the image data. For example, the counter 101 analyzes image data for each page, as shown in an example of FIG. 2, divides image data into square blocks BL of 14 rows (first row to fourteenth row) in a transport direction CD (in FIG. 2, a longitudinal direction) and 10 columns (A column to J column) in a width direction WD (in FIG. 2, a transverse direction), and counts the number of dots for each block BL. Here, for ease of description, while a case where the number of blocks is 140 (=10×14) is shown, it is preferable that the size of the block BL be made smaller to increase the number of blocks BL.

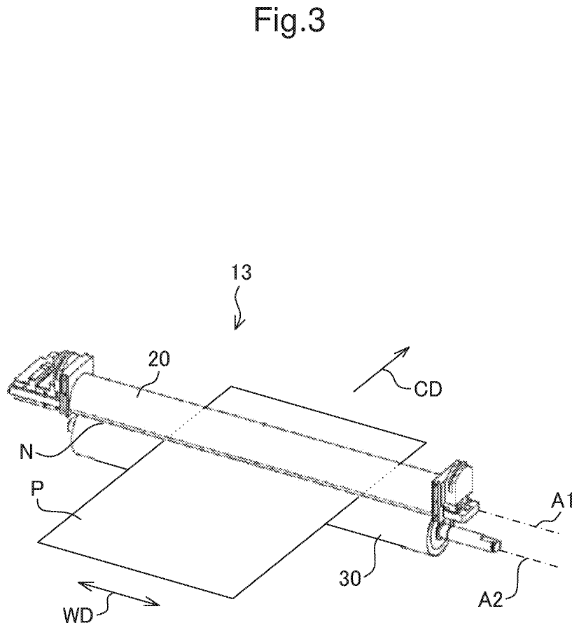

FIG. 3 is a perspective view showing an example of the fixing device 13 provided in the image forming apparatus 1. The fixing device 13 includes a cylindrical rotatable fixing belt 20 and a pressing part 30. The fixing belt 20 heats a recording medium P to which an image is transferred, with a heater provided inside. The fixing belt 20 can rotationally travel around a first rotation axis A1, and a width thereof extends in a direction of the first rotation axis A1. The fixing belt 20 is an example of a fixing part in the claims.

The pressing part 30 is a roller that is rotatable around a second rotation axis A2 parallel to the first rotation axis A1, and extends in a direction of the second rotation axis A2. The pressing part 30 forms a fixing nip portion N in which the recording medium P is nipped and transported, with the fixing belt 20, and rotates the fixing belt 20 in a driven manner. An arrow CD indicates the transport direction of the recording medium P. An arrow WD indicates the width direction perpendicular to the transport direction CD.

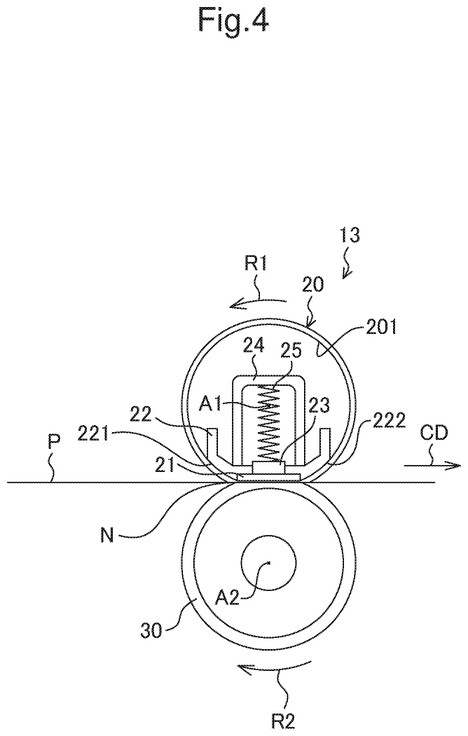

FIG. 4 is a cross-sectional view schematically showing an example of the fixing device 13. The fixing device 13 includes the fixing belt 20, the pressing part 30, a heater 21, a heater holder 22, a temperature sensor 23, a support 24, and a biasing part 25.

The fixing belt 20 rotates in a first rotation direction R1 (in FIG. 4, a counterclockwise direction) around the first rotation axis A1 following the rotation of the pressing part 30 around the second rotation axis A2 in a second rotation direction R2 (in FIG. 4, a clockwise direction). The fixing belt 20 has a cylindrical shape, and a circumferential surface thereof rotates in a circumferential direction.

The heater 21 heats the fixing belt 20 from the inner side of the fixing belt 20. The heater 21 is a sheet-shaped heater extending along the direction of the first rotation axis A1, is disposed on the inner side of the fixing belt 20 and faces an inner circumferential surface 201 of the fixing belt 20. The heater 21 is, for example, a ceramic heater, and includes a ceramic substrate and a heat generating resistor.

The heater holder 22 holds the heater 21. The heater holder 22 is a heat resistant resin part that has a U-shaped cross section and extends along the direction of the first rotation axis A1. The heater holder 22 has facing surfaces 221 and 222 facing the inner circumferential surface 201 of the fixing belt 20 on upstream and downstream sides in the transport direction CD of the recording medium P, respectively.

The temperature sensor 23 faces the heater 21 and detects a temperature of the heater 21. The temperature sensor 23 is inserted into a through-hole formed in the heater holder 22 and abuts on the heater 21. The temperature sensor 23 is, for example, a thermistor.

The support 24 is a metal stay that has an inverted U-shaped cross section and extends along the direction of the first rotation axis A1. The support 24 is fixed to a main body housing of the fixing device 13. The heater holder 22 is attached to the main body housing movably in directions toward and away from the support 24. The support 24 supports the posture of the heater holder 22 when an end portion on a side of the heater holder 22 is in contact with the heater holder 22.

The biasing part 25 is disposed between the temperature sensor 23 and the support 24, and presses the temperature sensor 23. The biasing part 25 is, for example, a coil spring. This configuration is an example, and is not intended to limit the configurations of the present disclosure to this configuration.

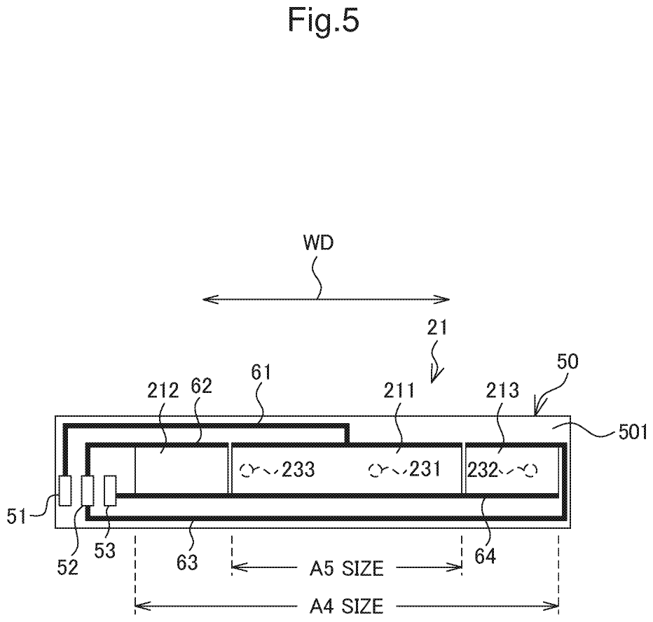

The heater 21 is divided along the width direction WD perpendicular to the transport direction CD of the recording medium P and each divided heater is configured to selectively heat. FIG. 5 is a plan view schematically showing an example of the configuration of the heater 21.

The heater 21 includes a substrate 50. The substrate 50 is, for example, a ceramic substrate, and has two principal surfaces parallel to each other. One of these surfaces is a heat generating surface. On the heat generating surface 501, a main heater 211, a first sub-heater 212, a second sub-heater 213, a first power feeder 51, a second power feeder 52, a third power feeder 53, a first wire 61, a second wire 62, a third wire 63, and a fourth wire 64 are provided. Each of the main heater 211, the first sub-heater 212, and the second sub-heater 213 is a heat generating resistor.

The main heater 211 is disposed in a central portion in the width direction WD. The first sub-heater 212 is disposed in one end portion in the width direction WD, and the second sub-heater 213 is disposed in the other end portion in the width direction WD. A length of the main heater 211 in the width direction WD is the A5 size, and a length between an outer end portion of the first sub-heater 212 and an outer end portion of the second sub-heater 213 is the A4 size.

The main heater 211 is connected to the first power feeder 51 via the first wire 61. The first sub-heater 212 and the second sub-heater 213 are connected to the second power feeder 52 via the second wire 62 and the third wire 63, respectively. The main heater 211, the first sub-heater 212, and the second sub-heater 213 are connected to the third power feeder 53 via the fourth wire 64.

The first power feeder 51, the second power feeder 52, and the third power feeder 53 are connected to an electrode. For example, the first power feeder 51 and the second power feeder 52 are connected to a positive pole of the electrode, and the third power feeder 53 is connected to a negative pole of the electrode.

As shown in FIG. 4, the fixing device 13 includes the temperature sensor 23 that detects the temperature of the heater 21. As shown in FIG. 5, the temperature sensor 23 has a main temperature sensor 231 that detects a temperature of the main heater 211, and a sub-temperature sensor 232 that detects one of the two sub-heaters (the first sub-heater 212 and the second sub-heater 213).

The main temperature sensor 231 is supported substantially in a central portion with respect to a longitudinal direction of the main heater 211 to face the main heater 211 on a non-heat generating surface (a principal surface opposite to the heat generating surface 501) of the substrate 50. The sub-temperature sensor 232 is supported to face the second sub-heater 213 on the non-heat generating surface of the substrate 50.

The controller 100 shown in FIG. 1 controls the driving of the heater 21 on the basis of a detection temperature by the temperature sensor 23 (the main temperature sensor 231 and the sub-temperature sensor 232).

On the non-heat generating surface of the substrate 50, an excessive temperature increase sensor 233 that detects a temperature of an excessive temperature increase region is disposed. The excessive temperature increase sensor 233 is supported closer to the end portion than the central portion in the longitudinal direction of the main heater 211 to face the main heater 211. The excessive temperature increase sensor 233 is, for example, a thermistor.

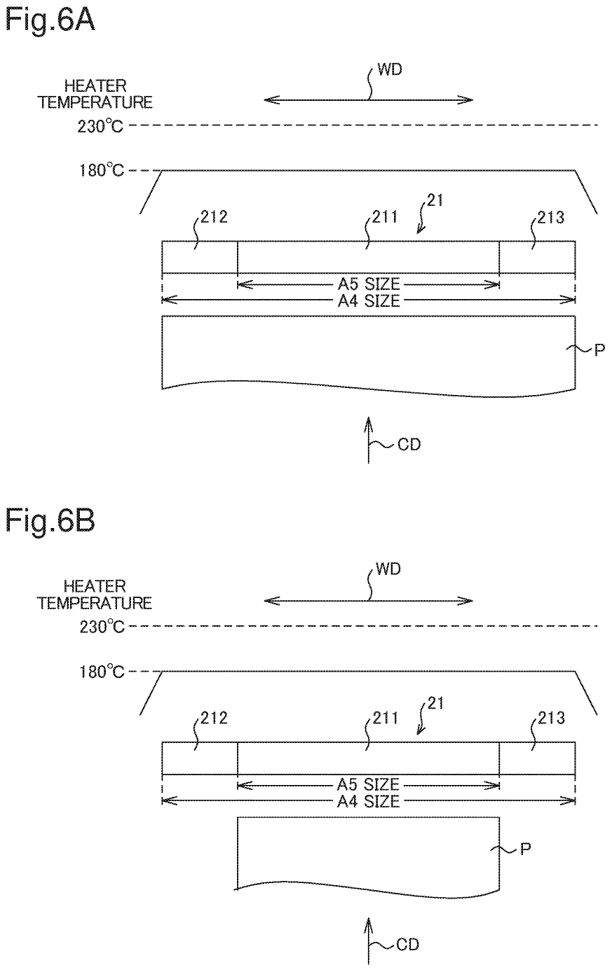

FIGS. 6A and 6B are image diagrams showing an example of a temperature distribution of the heater 21. As shown in FIG. 6A, when the recording medium P of the A4 size is caused to pass through the fixing nip portion N, because an entire region corresponding to the heater 21 becomes a sheet passing region, the heater 21 is maintained at a given temperature (for example, 180 °C). No excessive temperature increase region occurs.

As shown in FIG. 6B, when the recording medium P of the A5 size is caused to pass through the fixing nip portion N, an entire region corresponding to the main heater 211 is a sheet passing region, and an entire region corresponding to the first sub-heater 212 and the second sub-heater 213 becomes a non-sheet passing region. For this reason, the heater 21 is also maintained at a given temperature (for example, 180 °C), and no excessive temperature increase region is formed.

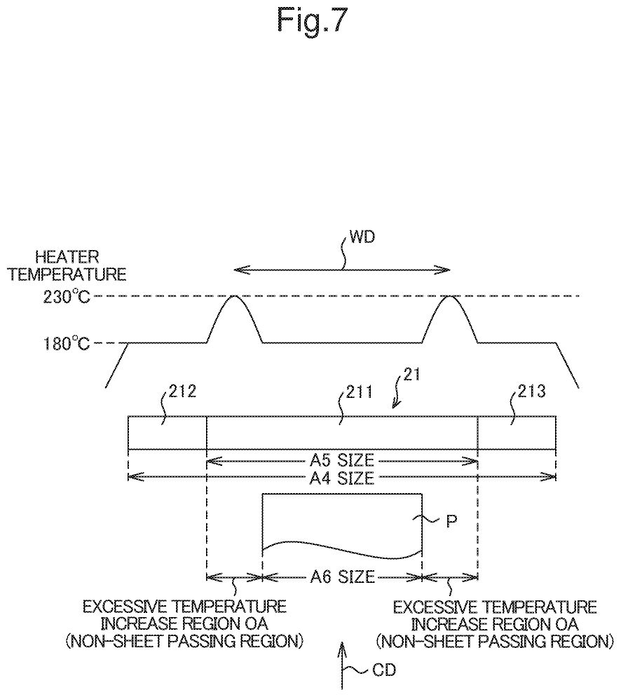

FIG. 7 is an image diagram showing another example of a temperature distribution of the heater 21. When the recording medium P (A6 size) having a width smaller than the A5 size is caused to pass through the fixing nip portion N, both a sheet passing region and a non-sheet passing region are present in a region corresponding to the main heater 211. A non-sheet passing region (an example of a first region) near the outer end portion of the main heater 211 is excessively increased in temperature (for example, 230 °C), and an excessive temperature increase region OA is formed.

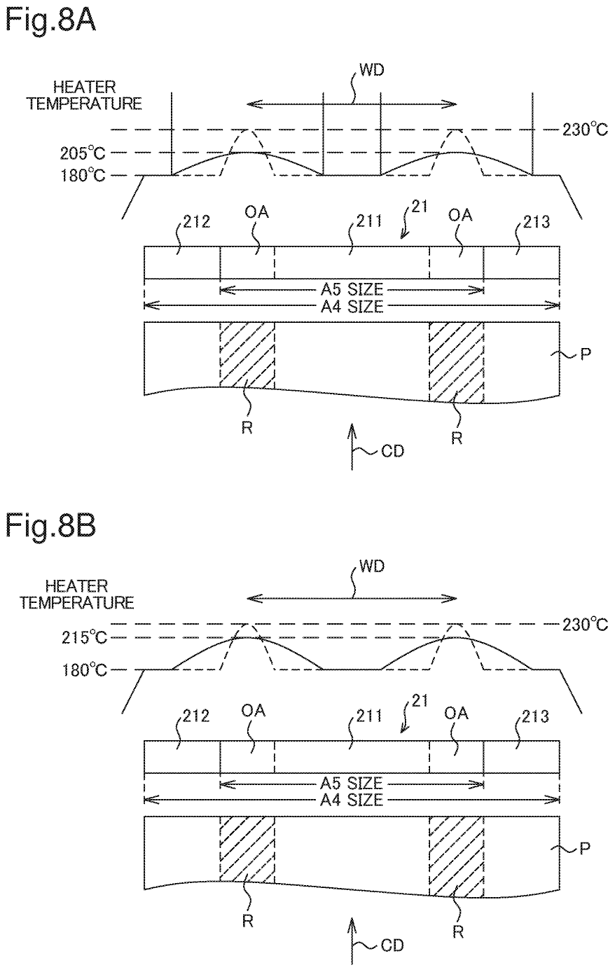

When a second recording medium P2 having a size in the width direction WD perpendicular to the transport direction CD of the recording medium P greater than a first recording medium P1 passes through the fixing nip portion N subsequently to the first recording medium P1, and the second recording medium P2 passes through the excessive temperature increase region OA that is a non-sheet passing region through which the first recording medium P1 does not pass, and when an image is formed in corresponding region R (see FIGS. 8A and 8B) of the second recording medium P2 that passes through the excessive temperature increase region OA, the controller 100 (FIG. 1) causes the second recording medium P2 to arrive at the fixing nip portion N with the transport device 15 when a temperature of the excessive temperature increase region OA becomes lower than a predetermined first threshold temperature TH1 (for example, 205 °C) (drives and controls the transport device 15 to cause the second recording medium P2 not to arrive at the fixing nip portion N until the temperature of the excessive temperature increase region OA becomes lower than the first threshold temperature TH1).

On the other hand, when no image is formed in the corresponding region R of the second recording medium P2 overlapping the excessive temperature increase region OA, the controller 100 causes the second recording medium P2 to arrive at the fixing nip portion N with the transport device 15 when the temperature of the excessive temperature increase region OA becomes lower than a predetermined second threshold temperature TH2 (for example, 215 °C) higher than the first threshold temperature TH1 (drives and controls the transport device 15 to cause the second recording medium P2 not to arrive at the fixing nip portion N until the temperature of the excessive temperature increase region OA becomes lower than the second threshold temperature TH2).

FIGS. 8A and 8B are image diagrams showing an example of a temperature distribution of the heater 21. When an image is formed in the corresponding region R of the second recording medium P2 overlapping the excessive temperature increase region OA, as shown in FIG. 8A, the controller 100 drives and controls the transport device 15 such that the transport device 15 causes the second recording medium P2 to arrive at the fixing nip portion N when the temperature of the excessive temperature increase region OA becomes lower than the first threshold temperature TH1 (205 °C).

On the other hand, when no image is formed in the corresponding region R of the second recording medium P2 overlapping the excessive temperature increase region OA, as shown in FIG. 8B, the controller 100 drives and controls the transport device 15 such that the transport device 15 causes the second recording medium P2 to arrive at the fixing nip portion N when the temperature of the excessive temperature increase region OA becomes lower than the second threshold temperature TH2 (215 °C).

When a halftone image is formed in the corresponding region R of the second recording medium P2 overlapping the excessive temperature increase region OA, the controller 100 drives and controls the transport device 15 such that the transport device 15 causes the second recording medium P2 to arrive at the fixing nip portion N when the temperature of the excessive temperature increase region OA becomes lower than a third threshold temperature TH3 (for example, 195 °C) lower than the predetermined first threshold temperature TH1.

For the determination about whether an image is formed in the corresponding region R of the second recording medium P2 overlapping the excessive temperature increase region OA, for example, the number of dots of each block BL counted by the counter 101 is used.

For example, the controller 100 calculates a total value V of the number of dots in each block BL included in the corresponding region R on the basis of the number of dots of each block BL counted by the counter 101, determines that no image is formed in the corresponding region R when the total value V is equal to or smaller than a predetermined numerical value (0 or a value close to 0), and determines that an image is formed in the corresponding region R when the total value V is not equal to or smaller than the predetermined numerical value.

The counter 101 may not be provided, and the controller 100 may determine whether a colored pixel is present in a data portion corresponding to the corresponding region of the recording medium, on the basis of image data to be a target for image forming by the image forming device 12 (whether dots are present), and may determine that an image is formed in the corresponding region R of the second recording medium P2 overlapping the excessive temperature increase region OA when colored pixels are present in the data portion.

Further, the controller 100 calculates a printing ratio on the basis of the total value V, and determines whether a halftone image is formed in the corresponding region R, from the calculated printing ratio. For example, when a printing ratio of 100% is defined as a maximum value, the controller 100 determines an image with a printing ratio equal to or greater than 5% and equal to or smaller than 80% to be a halftone image.

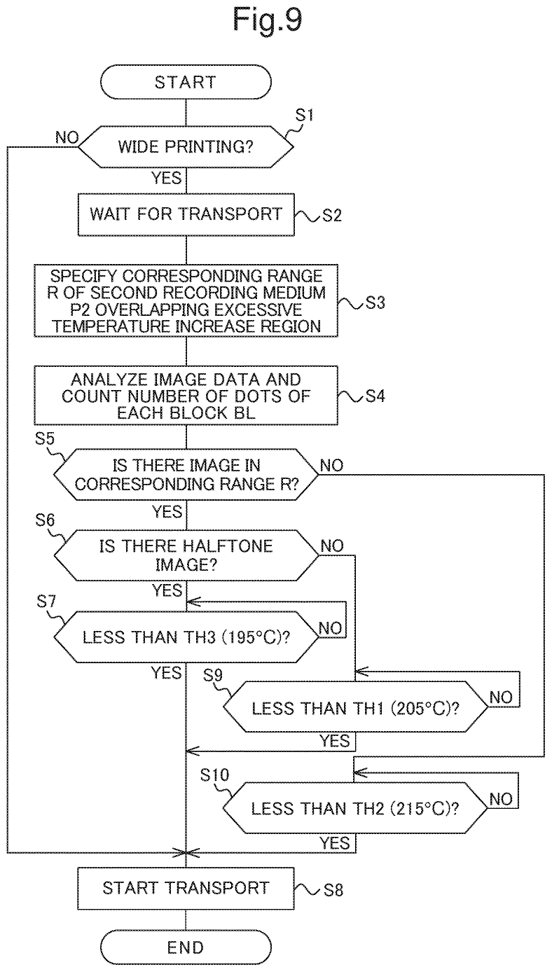

Next, an example of processing regarding temperature suppression of the fixing device 13 that is performed by the control device 10 of the image forming apparatus 1 will be described using a flowchart shown in FIG. 9. This processing is processing that is executed for one printed page during continuous printing on a plurality of recording media P.

The controller 100 determines whether the size in the width direction WD of the second recording medium P2 that will be next printed subsequently to the first recording medium P1 is greater than the first recording medium P1 (that is, whether next printing becomes “wide printing”) (S1).

When determination is made that next printing becomes “wide printing” (in S1, YES), the controller 100 controls the driving of the transport rollers 151 of the transport device 15 to temporarily stop the transport of the second recording medium P2 or to decrease a transport speed after a trailing end portion of the first recording medium P1 has passed through the fixing nip portion N, and waits without causing the second recording medium P2 to pass through the fixing nip portion N (S2). The controller 100 performs the determination about whether the trailing end portion of the first recording medium P1 has passed through the fixing nip portion N, on the basis of a detection result of the presence/absence detection sensor 152.

Subsequently, the controller 100 specifies the corresponding region R of the second recording medium P2 overlapping the excessive temperature increase region OA on the basis of the size of the first recording medium P1 and the size of the second recording medium P2 (S3), and the counter 101 analyzes image data indicating an image formed in the second recording medium P2 and counts the number of dots based on the image data for each of a plurality of blocks BL (S4). Thereafter, the controller 100 determines whether an image is formed in the corresponding region R, on the basis of a counting result of the counter 101 (S5).

When determination is made that an image is formed in the corresponding region R (in S5, YES), the controller 100 determines whether a halftone image is formed in the corresponding region R (S6). When determination is made that a halftone image is formed in the corresponding region R (in S6, YES), the controller 100 determines whether the detection temperature of the excessive temperature increase sensor 233 is lower than the third threshold temperature TH3 (195 °C) (S7).

When determination is made that the above-described detection temperature is lower than the third threshold temperature TH3 (in S7, YES), the controller 100 controls the driving of the transport rollers 151 of the transport device 15 to start the transport of the second recording medium P2 (S8). Thereafter, the processing ends.

On the other hand, when determination is made that no halftone image is formed in the corresponding region R (in S6, NO), the controller 100 determines whether the detection temperature of the excessive temperature increase sensor 233 is lower than the first threshold temperature TH1 (205 °C) (S9).

When determination is made that the above-described detection temperature is lower than the first threshold temperature TH1 (in S9, YES), the controller 100 controls the driving of the transport rollers 151 of the transport device 15 to start the transport of the second recording medium P2 (S8).

In the processing of S5, when determination is made that no image is formed in the corresponding region R (in S5, NO), the controller 100 determines whether the detection temperature of the excessive temperature increase sensor 233 is lower than the second threshold temperature TH2 (215 °C) (S10).

When determination is made that the above-described detection temperature is lower than the second threshold temperature TH2 (in S10, YES), the controller 100 controls the driving of the transport rollers 151 of the transport device 15 to start the transport of the second recording medium P2 (S8).

On the other hand, in the processing of S1, when determination is made that next printing does not become “wide printing” (in S1, NO), the controller 100 controls the driving of the transport rollers 151 of the transport device 15 to start the transport of the second recording medium P2 without performing the processing of S2 to S7, S9, and S10 (S8). Thereafter, the processing ends.

Incidentally, a fixing device in which a heater that heats the fixing belt is enabled to selectively heat each of a plurality of regions divided in a rotation axis direction of the fixing belt (the width direction of the recording sheet) is known. The heater is a sheet-shaped heater that extends along the width direction perpendicular to the transport direction of the recording medium. In this way, when recording sheets having different sheet widths are continuously transported to the fixing device and fixing is performed thereon, because heat is not taken away by the recording sheet in a region through which the recording sheet does not pass, of the fixing belt, an excessive temperature increase occurs. Meanwhile, because the heater can selectively heat each of a plurality of regions divided in the width direction of the recording sheet, a region where an excessive temperature increase occurs is made different, compared to the case of heating using a heater configured to heat an entire region in the width direction at once. However, the general technique described above does not take into consideration means for reducing a waiting time until work for image forming starts, in response to a condition of an excessive temperature increase that occurs in fixing through heating by a heater configured to selectively heat in each of a plurality of regions divided in the width direction of the recording sheet.

In contrast, according to the first embodiment, when the second recording medium P2 passes through the excessive temperature increase region OA, because the second recording medium P2 is caused to pass through the fixing nip portion N after waiting for a decrease in temperature of the excessive temperature increase region OA, it is possible to suppress the occurrence of hot offset.

Further, when an image is formed in the corresponding region R of the second recording medium P2 overlapping the excessive temperature increase region OA, even when the temperature of the excessive temperature increase region OA becomes lower than the second threshold temperature TH2 (215 °C), it is not possible to start the transport of the second recording medium P2. Meanwhile, when no image is formed in the corresponding region R, and when the temperature of the excessive temperature increase region OA becomes lower than the second threshold temperature TH2, the transport of the second recording medium P2 starts.

That is, when no image is formed in the corresponding region R, it is possible to reduce the waiting time (downtime) of the second recording medium P2, compared to when an image is formed in the corresponding region R, and as a result, it is possible to improve productivity. Therefore, when a configuration in which the fixing part is heated by the heater configured to selectively heat each of a plurality of regions divided in the width direction of the recording sheet is employed, it is possible to suppress harmful effects such as hot offset and to improve productivity.

In general, while a halftone image is likely to undergo an image defect due to an excessive temperature increase compared to a line image or a solid image, in the first embodiment, when a halftone image is formed in the corresponding region R, the transport of the second recording medium P2 is caused to wait until the temperature of the excessive temperature increase region OA becomes lower than the third threshold temperature TH3 (195 °C). With this, it is possible to more appropriately suppress the occurrence of harmful effects such as hot offset.

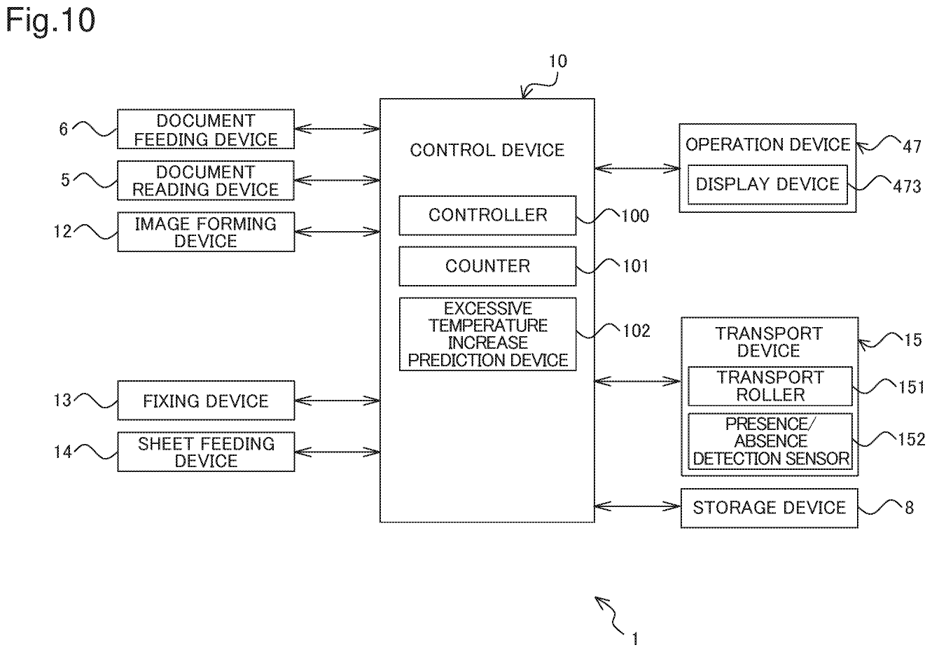

FIG. 10 is a functional block diagram schematically showing a main internal configuration of an image forming apparatus according to a second embodiment. In the description of the second embodiment, description of configurations or processing similar to those in the first embodiment will not be repeated. In the second embodiment, the control device 10 further functions as an excessive temperature increase prediction device 102 in addition to the controller 100 and the counter 101 by an operation of the above-described processor according to the control program stored in the storage device 8, or the like.

The excessive temperature increase prediction device 102 calculates a waiting time required until the temperature of the excessive temperature increase region OA becomes the first and second threshold temperatures or a waiting time required until the temperature of the excessive temperature increase region OA becomes the first to third threshold temperatures, on the basis of the detection temperature of the temperature sensor 23 and a predetermined parameter having an influence on the temperature of the excessive temperature increase region OA. As the above-described parameter, for example, before shipment of the image forming apparatus 1, after the heater 21 (main heater 211) is driven and the recording medium P having a small width is caused to pass through a sheet passing region of the fixing device 13 and is subjected to a fixing operation by an experiment or the like, when the recording medium P is caused to wait without passing through the fixing nip portion N of the fixing device 13 in a state in which the heater 21 (the main heater 211) is driven to be maintained at a given temperature (for example, 180 °C), a waiting time required until the temperature of the excessive temperature increase region OA becomes the first and second threshold temperatures or a required time until the temperature of the excessive temperature increase region OA becomes the first to third threshold temperatures is acquired and stored in a non-volatile memory of the control device 10. In this experiment, the experiment is performed taking into consideration a temperature and humidity of an installation environment, a size in the width direction of a recording material passing therethrough, a basis weight, the number of sheets having passed therethrough per unit time and an integrated value, or the like, the required time may be acquired under different conditions and stored in the non-volatile memory of the control device 10, and the excessive temperature increase prediction device 102 may select the required time suitable for each condition to calculate the above-described waiting time.

The excessive temperature increase prediction device 102 calculates a waiting time required until the temperature of the excessive temperature increase region OA becomes the first and second threshold temperatures or becomes the first to third threshold temperatures, on the basis of the detection temperature of the temperature sensor 23 with the required time as a parameter. When the heater 21 (main heater 211) is driven and a recording medium P having a small width is caused to pass through the sheet passing region of the fixing device 13 and is subjected to a fixing operation, and when the waiting time calculated by the excessive temperature increase prediction device 102 has elapsed, the controller 100 drives and controls the transport device 15 such that the transport device 15 causes the second recording medium P2 to arrive at the fixing nip portion N.

In the first embodiment, the controller 100 controls the transport of the second recording medium P2 on the basis of the detection result of the excessive temperature increase sensor 233. In contrast, the second embodiment is different from the first embodiment in that the controller 100 controls the transport of the second recording medium P2 on the basis of the calculation result of the excessive temperature increase prediction device 102. With this, it is possible to make the excessive temperature increase sensor 233 unnecessary.

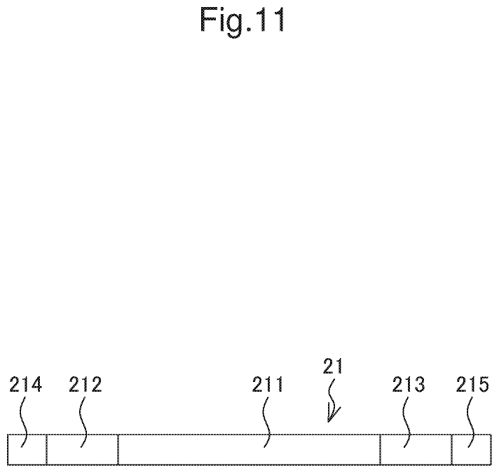

The present disclosure is not limited to the configurations of the above-described embodiments, and various modifications can be made. For example, as shown in FIG. 11, the present disclosure can be applied to a configuration in which the heater 21 is divided into five heaters (a main heater 211, a first sub-heater 212, a second sub-heater 213, a third sub-heater 214, and a fourth sub-heater 215) in the width direction, or the like.

The configuration and the processing described in the above-described embodiment with reference to FIGS. 1 to 11 are merely one embodiment of the present disclosure, and are not intended to limit the present disclosure to the configuration and the processing.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising:
an image forming device configured to form an image based on image data on a recording medium;
a transport device configured to continuously transport a plurality of the recording media in a transport path on which the recording medium is to be transported;
a fixing part that has a cylindrical shape and is configured to be rotatable;
a heater configured to heat the fixing part to a predetermined fixing temperature;
a pressing part configured to hold the fixing part between itself the heater, form a fixing nip portion in which the recording medium after image forming by the image forming device is nipped and transported, with the fixing part, and rotate the fixing part in a driven manner;
a temperature sensor configured to detect a temperature of the heater; and
a control device that includes a processor and functions as a controller configured to control driving of the heater on the basis of a detection temperature of the temperature sensor by the processor executing a control program,
wherein the heater selectively heats each region divided along a rotation axis direction of the fixing part, and
the controller is configured to
when a second recording medium having a size in a width direction perpendicular to a transport direction of the recording medium greater than a first recording medium passes through the fixing nip portion subsequently to the first recording medium, and when the second recording medium passes through a first region through which the first recording medium does not pass,
cause, when an image is formed in a corresponding region of the second recording medium formed when passing through the first region, the transport device to transport the second recording medium to the fixing nip portion when a temperature of the first region becomes lower than a predetermined first threshold temperature, and
cause, when no image is formed in the corresponding region of the second recording medium overlapping the first region, the transport device to transport the second recording medium to the fixing nip portion when the temperature of the first region becomes lower than a predetermined second threshold temperature higher than the first threshold temperature.

2. The image forming apparatus according to claim 1,
wherein the controller is configured to cause, when a halftone image is formed in the corresponding region of the second recording medium overlapping the first region, the transport device to transport the second recording medium to the fixing nip portion when the temperature of the first region becomes lower than a predetermined third threshold temperature lower than the first threshold temperature.

3. The image forming apparatus according to claim 1, further comprising:
an excessive temperature increase sensor configured to detect the temperature of the first region,
wherein the controller is configured to control transport of the second recording medium on the basis of a detection result of the excessive temperature increase sensor.

4. The image forming apparatus according to claim 1,
wherein the control device further functions as an excessive temperature increase prediction device configured to calculate a waiting time required until the temperature of the first region becomes the first to third threshold temperatures, on the basis of the detection temperature of the temperature sensor and a predetermined parameter having an influence on the temperature of the first region, and
the controller is configured to control transport of the second recording medium on the basis of a calculation result of the excessive temperature increase prediction device.

5. The image forming apparatus according to claim 2,
wherein the controller is configured to calculate a printing ratio on the basis of the number of dots of each block included in the corresponding region and determine that a halftone image is formed in the corresponding region when the calculated printing ratio is a value within a predetermined range.

6. The image forming apparatus according to claim 1,
wherein the controller is configured to determine that an image is formed in the corresponding region when colored pixels are present in a data portion corresponding to the corresponding region, and determine that no image is formed in the corresponding region when no colored pixels are present.
